(19) United States
(12) Patent Application Publication
(10) Pub. No.: US 2017/0277227 A1
(43) Pub. Date: Sep. 28, 2017

(54) KEYBOARD AND NOTEBOOK COMPUTER WITH SAME

(71) Applicant: Primax Electronics Ltd., Neihu (TW)

(72) Inventors: YI-TE CHOU, Neihu (TW); YI-CHEN WANG, Neihu (TW)

(21) Appl. No.: 15/161,009

(22) Filed: May 20, 2016

(30) Foreign Application Priority Data
Mar. 25, 2016 (TW) 105109435

(51) Int. Cl. G06F 1/16; H01H 13/705; H01H 13/85; H01H 13/10

(52) U.S. Cl. CPC G06F 1/1662; H01H 13/10; H01H 13/705; H01H 13/85

(57) ABSTRACT

A keyboard and a notebook computer with the keyboard are provided. The keyboard includes a membrane circuit board and plural keys. Each key includes a keycap, a bulge and a key frame. The bulge is connected with the keycap. The key frame has a guiding groove corresponding to the bulge. When the keyboard is in a usage status, the bulge is not pushed by the guiding groove and thus the keycap is at a higher position. Since the keycap is at the higher position, the movable distance of the keycap is increased and the tactile feel of depressing the keycap is enhanced. While a top cover of the notebook computer is closed to cover the keyboard, the key frame is moved horizontally. As the bulge is pushed by the guiding surface of the guiding groove, the height of the keycap is lowered.

### FIELD OF THE INVENTION

The present invention relates to an input device, and more particularly to a keyboard and a notebook computer with the keyboard.

### BACKGROUND OF THE INVENTION

Generally, the widely-used peripheral input device of a computer system includes for example a mouse, a keyboard, a trackball, or the like. Via the keyboard, characters or symbols can be directly inputted into the computer system. As a consequence, most users and most manufacturers of input devices pay much attention to the development of keyboards.

FIG. 1 is a schematic side view illustrating a portion of a conventional keyboard. As shown in FIG. 1, the keyboard 1 comprises a base plate 11, a membrane circuit board 12 and plural keys 13. Each key 13 comprises a keycap 131, a scissors-type connecting element 132 and an elastic element 133. The membrane circuit board 12 is disposed over the base plate 11. Moreover, the membrane circuit board 12 comprises plural membrane switches 121 corresponding to the plural keys 13.

The elastic element 132 is arranged between the keycap 131 and the membrane circuit board 12. The scissors-type connecting element 132 comprises a first frame 1321 and a second frame 1322. The keycap 131 comprises a first keycap fixing structure 1311 and a second keycap fixing structure 1312. The base plate 11 comprises a first base fixing structure 111 and a second base fixing structure 112. The first base fixing structure 111 and the second base fixing structure 112 are penetrated through the membrane circuit board 12. Two ends of the first frame 1321 are connected with the second base fixing structure 112 of the base plate 11 and the first keycap fixing structure 1311 of the keycap 131, respectively. Two ends of the second frame 1322 are connected with the first base fixing structure 111 of the base plate 11 and the second keycap fixing structure 1312 of the keycap 131, respectively.

The key 13 of the keyboard 1 in the right side of FIG. 1 is in an initial state. That is, the keycap 131 is not depressed. The key 13 of the keyboard 1 in the left side of FIG. 1 is depressed and thus in a depressed state. While the keycap 131 of any key 13 is depressed and moved downwardly relative to the base plate 11, the first frame 1321 and the second frame 1322 of the scissors-type connecting element 132 are switched from an open-scissors state to a folded state. Moreover, as the keycap 131 is moved downwardly to compress the elastic element 133, the corresponding membrane switch 121 is pushed by the elastic element 133. Consequently, the keyboard 1 generates a corresponding key signal. When the keycap 131 of the key 13 is no longer depressed, the keycap 131 is moved upwardly relative to the base plate 11 in response to an elastic force of the elastic element 133. Meanwhile, the first frame 1321 and the second frame 1322 of the scissors-type connecting element 132 are switched from the folded state to the open-scissors state, and the keycap 131 is returned to its original position. The detailed structures and actions of the scissors-type connecting element 132 of the conventional key 13 are well known to those skilled in the art, and are not redundantly described herein.

Please refer to FIG. 1 again. The total height of the keyboard 1 is T1. When the keycap 131 of the key 13 is depressed, the height of the depressed keycap 131 is T2 and a travelling distance of the keycap 131 is T3. The total height T1 of the keyboard 1 is equal to the sum of T1 and T2.

Generally, in case the thickness of the keyboard 1 is reduced, the notebook computer with the keyboard 1 is slim and easily carried. For achieving this purpose, two approaches of reducing the thickness of the keyboard 1 are employed. In accordance with the first approach, the thicknesses of some components or all components are reduced. In accordance with the second approach, the travelling distance T3 of the keycap 131 is reduced. However, these approaches still have some drawbacks. In case that the first approach is adopted, the structural strength of the key 13 is impaired, and thus the keyboard 1 is easily damaged. In case that the second approach is adopted, the tactile feel of depressing the key is deteriorated. In other words, the conventional keyboard 1 and the notebook computer with the keyboard 1 need to be further improved.

### SUMMARY OF THE INVENTION

An object of the present invention provides a keyboard. In the keyboard, the height of the keycap is changeable through the key frame. Consequently, the keyboard has slim appearance, increased structural strength and enhanced tactile feel.

Another object of the present invention provides a notebook computer with the keyboard. Consequently, the notebook computer can be easily carried by the user.

In accordance with an aspect of the present invention, there is provided a keyboard. The keyboard includes a membrane circuit board, at least one key and a base plate. The membrane circuit board includes at least one membrane switch. The at least one key corresponds to the at least one membrane switch. Each key includes a keycap, a bulge and a key frame. When the keycap is depressed, the corresponding membrane switch is turned on. The bulge is connected with a lateral edge of the keycap and protruded externally from the keycap. The key frame includes a receiving hole and a guiding surface corresponding to the bulge. The keycap is movable within the receiving hole. While the key frame is moved horizontally, the bulge is pushed by the guiding surface and moved along the guiding surface, so that the keycap is descended. The base plate is connected with the at least one key.

In accordance with another aspect of the present invention, there is provided a notebook computer. The notebook computer includes a keyboard base, a top cover and a keyboard. The top cover is pivotally coupled with the keyboard base. The keyboard is installed on the keyboard base. The keyboard includes a membrane circuit board, at least one key and a base plate. The membrane circuit board includes at least one membrane switch. The at least one key corresponds to the at least one membrane switch. Each key includes a keycap, a bulge and a key frame. When the keycap is depressed, the corresponding membrane switch is turned on. The bulge is connected with a lateral edge of the keycap and protruded externally from the keycap. The key frame includes a receiving hole and a guiding surface corresponding to the bulge. The keycap is movable within the receiving hole. The base plate is connected with the at least one key. While the top cover is moved from an opened position to a closed position, the key frame is moved horizontally in a first direction. As the key frame is moved horizontally in the first direction, the bulge is pushed by the guiding surface and moved along the guiding surface, so that the keycap is descended.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a portion of a conventional keyboard;

FIG. 2 is a schematic perspective view illustrating a portion of a keyboard according to an embodiment of the present invention;

FIG. 3 is a schematic exploded view illustrating the keyboard of FIG. 2 and taken along a viewpoint;

FIG. 4 is a schematic exploded view illustrating the keyboard of FIG. 2 and taken along another viewpoint;

FIG. 5A is a schematic cross-sectional view illustrating a portion of the keyboard of FIG. 2, in which the keycap is not depressed;

FIG. 5B is a schematic cross-sectional view illustrating a portion of the keyboard of FIG. 2, in which the keycap is depressed;

FIG. 5C is a schematic cross-sectional view illustrating a portion of the keyboard of FIG. 2 in the stored status;

FIG. 6 is a schematic perspective view illustrating the outward appearance of a notebook computer according to a first embodiment of the present invention;

FIG. 7A is a schematic side view illustrating the notebook computer of FIG. 6, in which the top cover is in the opened position;

FIG. 7B is a schematic side view illustrating the notebook computer of FIG. 7A, in which the top cover is moved from the opened position to the closed position;

FIG. 8A is a schematic side view illustrating a portion of a notebook computer according to a second embodiment of the present invention, in which the top cover is in the opened position;

FIG. 8B is a schematic side view illustrating the notebook computer of FIG. 8A, in which the top cover is moved from the opened position to the closed position;

FIG. 9A is a schematic side view illustrating a portion of a notebook computer according to a third embodiment of the present invention, in which the top cover is in the opened position;

FIG. 9B is a schematic side view illustrating the notebook computer of FIG. 9A, in which the top cover is moved from the opened position to the closed position;

FIG. 10A is a schematic side view illustrating a portion of a notebook computer according to a fourth embodiment of the present invention, in which the top cover is in the opened position; and

FIG. 10B is a schematic side view illustrating the notebook computer of FIG. 10A, in which the top cover is moved from the opened position to the closed position.

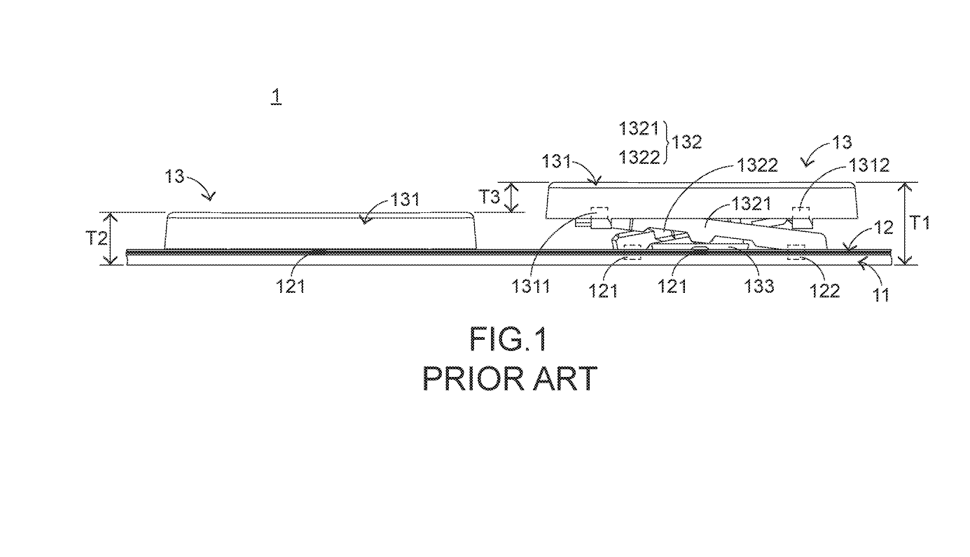

### DETAILED DESCRIPTION OF THE PREFERRED EMBODIMENT

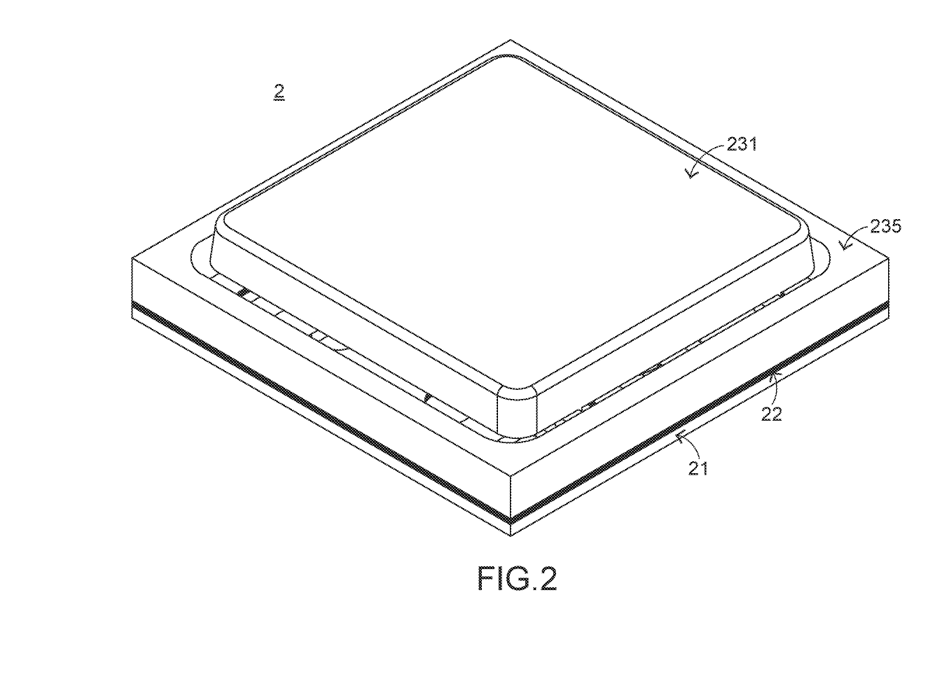

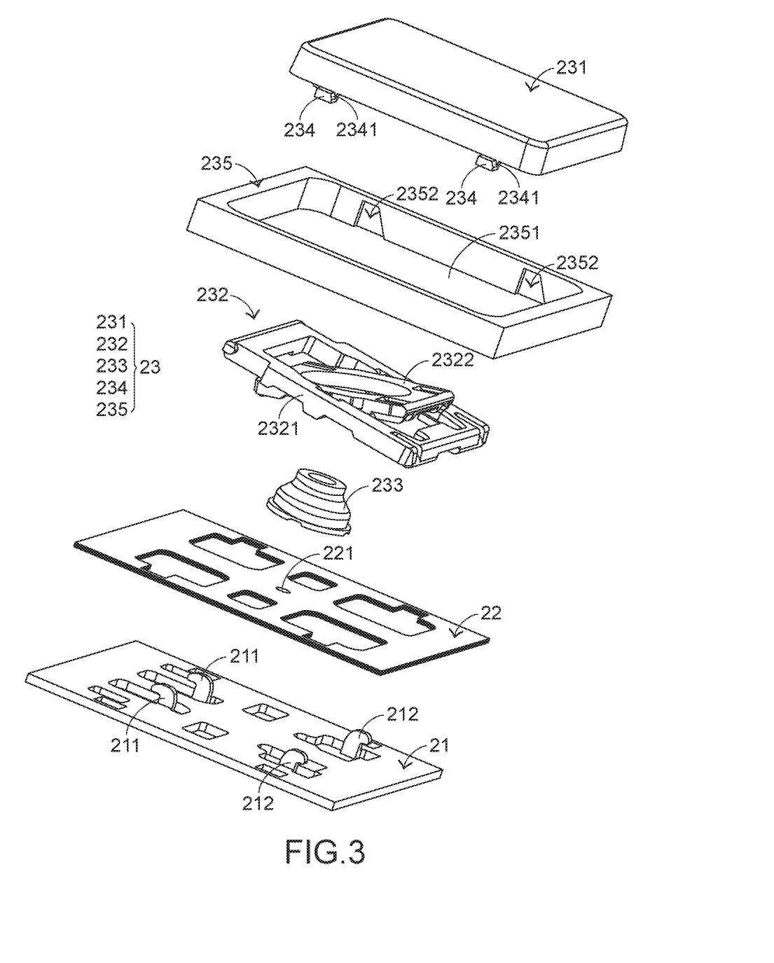

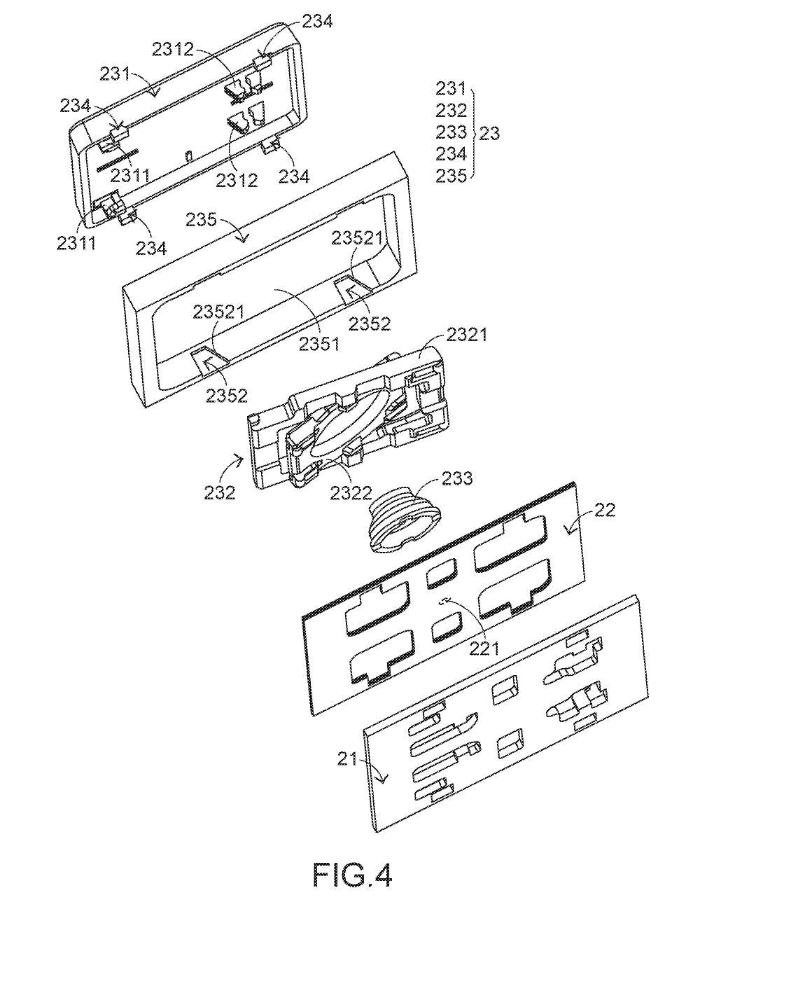

FIG. 2 is a schematic perspective view illustrating a portion of a keyboard according to an embodiment of the present invention. FIG. 3 is a schematic exploded view illustrating the keyboard of FIG. 2 and taken along a viewpoint. FIG. 4 is a schematic exploded view illustrating the keyboard of FIG. 2 and taken along another viewpoint. As shown in FIGS. 2, 3 and 4, the keyboard 2 comprises a base plate 21, a membrane circuit board 22 and plural keys 23. For succinctness, only one key 23 is shown in the drawings. The key 23 comprises a keycap 231, a bulge 234, a key frame 234, a connecting element 232 and an elastic element 233. The membrane circuit board 22 is disposed over the base plate 21. Moreover, the membrane circuit board 22 comprises a membrane switch 221 corresponding to the key 23.

The elastic element 233 is arranged between the keycap 231 and the membrane circuit board 22. The connecting element 232 is connected between the base plate 21 and the keycap 231. In this embodiment, the connecting element 232 is a scissors-type connecting element comprising a first frame 2321 and a second frame 2322. The keycap 231 comprises a first keycap fixing structure 2311 and a second keycap fixing structure 2312. The base plate 21 comprises a first base fixing structure 211 and a second base fixing structure 212. The first base fixing structure 211 and the second base fixing structure 212 are penetrated through the membrane circuit board 22. Two ends of the first frame 2321 are connected with the second base fixing structure 212 of the base plate 21 and the first keycap fixing structure 2311 of the keycap 231, respectively. Two ends of the second frame 2332 are connected with the first base fixing structure 211 of the base plate 21 and the second keycap fixing structure 2312 of the keycap 231, respectively. The connecting relationship between the connecting element 232, the base plate 21 and the keycap 231 is presented herein for purpose of illustration and description only.

The bulge 234 of the key 23 is connected with a lateral edge of the keycap 231 and protruded externally from the keycap 231. The key frame 235 of the key 23 is disposed over the base plate 21. Moreover, the key frame 235 comprises a receiving hole 2351 and a guiding groove 2352. The keycap 231 is movable within the receiving hole 2351. The guiding groove 2352 is concavely formed in an inner wall of the key frame 235. When the keycap 231 is not depressed, the bulge 234 is accommodated within the guiding groove 2352. The guiding groove 2352 has a guiding surface 23521. The bulge 234 has a bulge surface 2341 to be contacted with the guiding surface 23521 of the guiding groove 2352. Consequently, during the process of storing the keyboard 2, the keycap 231 is moved relative to the key frame 235 through the bulge surface 2341 and the guiding surface 23521. The process of storing the keyboard 2 will be illustrated in more details as follows.

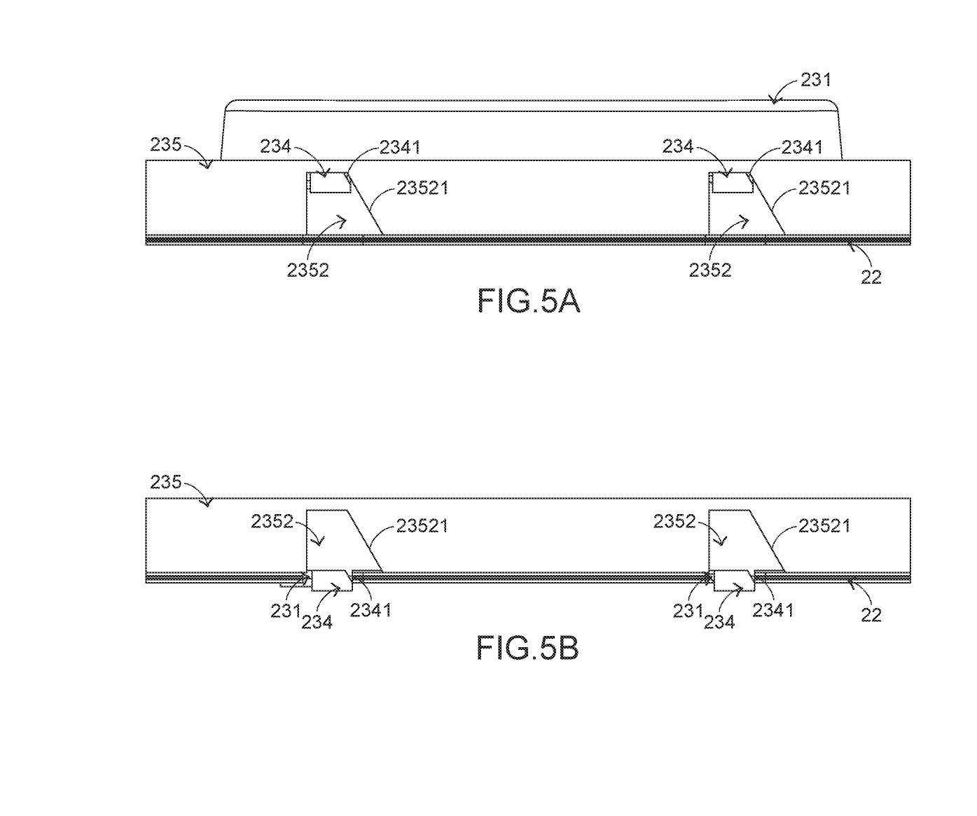

The operations of the keyboard 2 while the key 23 is depressed will be illustrated as follows. Please refer to FIGS. 5A and 5B. FIG. 5A is a schematic cross-sectional view illustrating a portion of the keyboard of FIG. 2, in which the keycap is not depressed. FIG. 5B is a schematic cross-sectional view illustrating a portion of the keyboard of FIG. 2, in which the keycap is depressed. While the keycap 231 of the key 23 is depressed and moved downwardly relative to the membrane circuit board 22, the bulge 234 connected with the keycap 231 is detached from the guiding groove 2352 of the key frame 235 and moved toward the membrane circuit board 22. Under this circumstance, the first frame 2321 and the second frame 2322 of the connecting element 232 are switched from an open-scissors state to a folded state. Moreover, as the keycap 231 is moved downwardly to compress the elastic element 233, the corresponding membrane switch 221 of the membrane circuit board 22 is pushed by the elastic element 233. Consequently, the keyboard 2 generates a corresponding key signal.

When the keycap 231 of the key 23 is no longer depressed, the keycap 231 is moved upwardly relative to the membrane circuit board 22 in response to an elastic force of the elastic element 233. As the keycap 231 is moved upwardly, the bulge 234 connected with the keycap 231 is moved toward the guiding groove 2352 of the key frame 235. Meanwhile, the first frame 2321 and the second frame 2322 of the connecting element 232 are switched from the folded state to the open-scissors state. Consequently, the keycap 231 is returned to its original position, and the bulge 234 of the keycap 231 is accommodated within the guiding groove 2352 of the key frame 235. Moreover, as shown in FIGS. 5A and 5B, the keyboard 2 is not in the stored status.

Hereinafter, a process of storing the keyboard 2 will be illustrated with reference to FIGS. 5A and 5C. FIG. 5C is a schematic cross-sectional view illustrating a portion of the keyboard of FIG. 2 in the stored status. While the key frame 235 is moved horizontally in a first direction D1, the bulge surface 2341 of the bulge 234 is pushed by the guiding surface 23521 of the guiding groove 2352 of the key frame 235 and thus the bulge surface 2341 is moved along the guiding surface 23521. Since the guiding surface 23521 is a bevel surface inclined downwardly, the keycap 231 connected with the bulge 234 is moved downwardly in the vertical direction with the movement of the bulge 234. On the other hand, while key frame 235 is moved horizontally in a second direction D2 opposite to the first direction D1, the bulge surface 2341 of the bulge 234 is no longer pushed by the guiding surface 23521 of the guiding groove 2352 of the key frame 235. In response to the elastic force of the elastic element 233, the keycap 231 connected with the bulge 234 is moved upwardly in the vertical direction. Under this circumstance, the keycap 231 is returned to its original position, and thus the keycap 231 can be depressed by the user.

As mentioned above, the height of the keycap 231 is lowered when the keyboard 2 is in the stored status. Consequently, the overall thickness of the keyboard 2 is reduced. Due to the slim appearance, the keyboard 2 can be carried more easily. When the keyboard 2 is restored to the non-stored status, the keycap 231 is ascended to the original height. That is, while the keycap 231 is depressed, the travelling distance of moving the keycap 231 downwardly in the vertical direction is increased. Since the travelling distance of the keycap 231 is increased, the tactile feel of depressing the keycap 231 is enhanced. Moreover, the thickness of the keyboard 2 is reduced without the need of reducing the thickness of any component of the keyboard 2. Consequently, the structured strength of the keyboard 2 is not adversely affected.

It is noted that the number of the keys 23 of the keyboard 2 is not restricted. In the above embodiment, each key 23 comprises four bulges 234, and each frame 235 comprises four guiding grooves 2352. It is noted that the number of the bulges 234 of each key 23 and the number of the guiding grooves 2352 of each key frame 235 are not restricted. That is, the number of the bulges 234 and the number of the guiding grooves 2352 may be altered by those skilled in the art according to the practical requirements. In FIG. 2, only a single key 23 of the keyboard 2 is shown. In practice, the number of the keyboard 2 is not restricted. In some embodiments, the keyboard 2 comprises plural keys 23. During the process of storing the keyboard 2, the keycaps 231 of all keys 23 are descended with the horizontal movement of the key frames 235 of the keys 23.

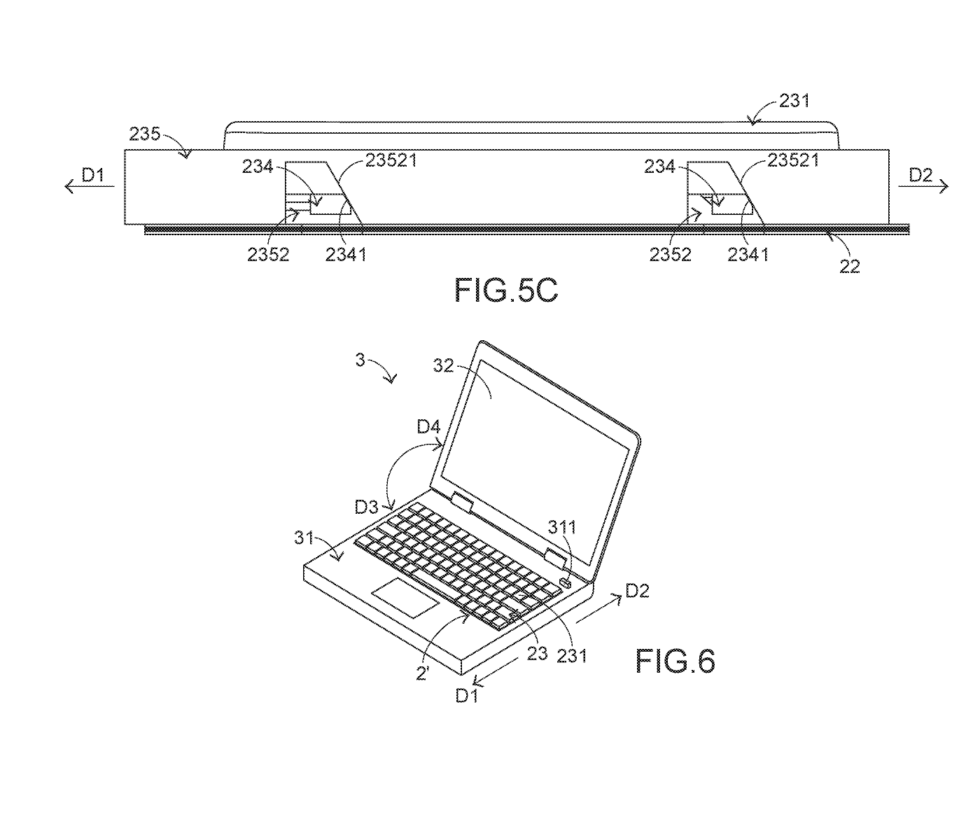

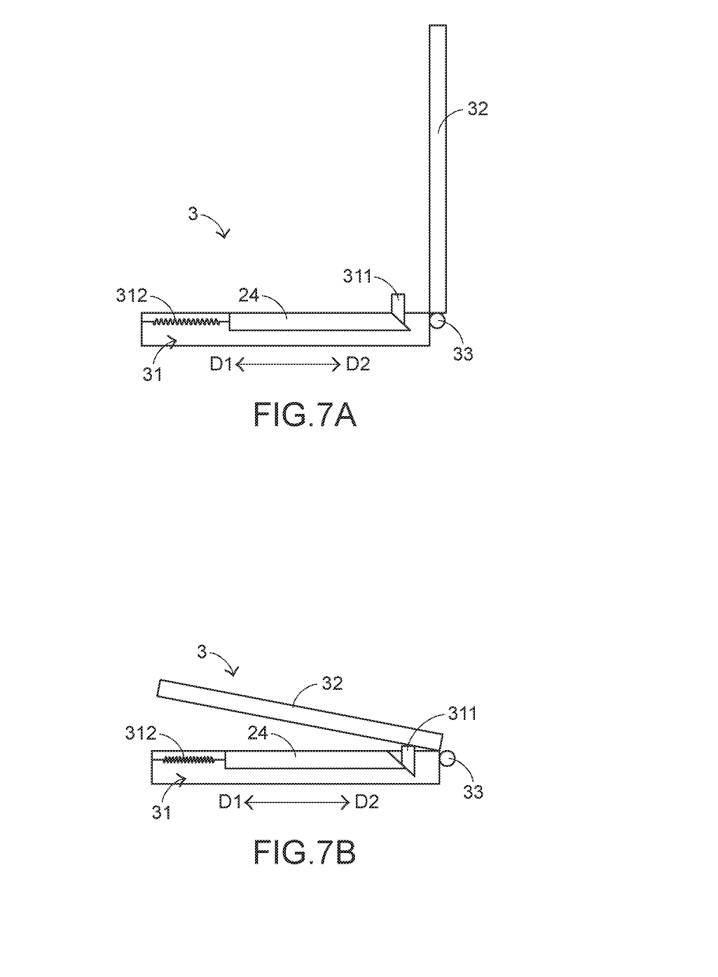

FIG. 6 is a schematic perspective view illustrating the outward appearance of a notebook computer according to a first embodiment of the present invention. As shown in FIG. 6, the notebook computer 3 comprises a keyboard base 31, a top cover 32, a rotary shaft 33 and a keyboard 2′. The keyboard 2′ is installed on the keyboard base 31. The top cover 32 is pivotally coupled with the keyboard base 31 through the rotary shaft 33 (see also FIGS. 7A˜10B). Consequently, the top cover 32 can be moved relative to the keyboard base 31 and from an opened position to a closed position in a direction D3, or the top cover 32 can be moved relative to the keyboard base 31 and from the closed position to the opened position in a direction D4. The keyboard 2′ comprises plural keys 23. The operations of these keys 23 are similar to the operations of the above key 23, and are not redundantly described herein.

Moreover, while the top cover 32 is moved from the opened position to the closed position, the key frame (not shown) of each key 23 in the keyboard base 13 is moved horizontally in the first direction D1. Consequently, as mentioned above, the keycap 231 of the key 23 is descended. Under this circumstance, the keyboard 2 is in a stored status. While the top cover 32 is moved from the closed position to the opened position, the key frame of each key 23 is moved horizontally in the second direction D2. Consequently, as mentioned above, the keycap 231 of the key 23 is ascended to be depressed.

Please refer to FIGS. 7A and 7B. FIG. 7A is a schematic side view illustrating the notebook computer of FIG. 6, in which the top cover is in the opened position. FIG. 7B is a schematic side view illustrating the notebook computer of FIG. 7A, in which the top cover is moved from the opened position to the closed position. In this embodiment, the key frames of the plural keys 23 are combined as a key frame module 24. Moreover, the keyboard base 31 comprises a linkage element 311 and an elastic mechanism 312. The linkage element 311 is movable upwardly or downwardly relative to the key frame module 24. The elastic mechanism 312 is connected with the key frame module 24 and an inner surface of the keyboard base 31. When the top cover 32 is in the opened position, a first end of the linkage element 311 is protruded externally from the surface of the keyboard base 31 and a second end of the linkage element 311 is contacted with the key frame module 24. While the top cover 32 is moved from the opened position to the closed position, the linkage element 311 is pushed by the top cover 32 and the linkage element 311 is descended. Moreover, as the linkage element 311 is descended, the key frame module 24 is pushed by the linkage element 311 and moved horizontally in the first direction D1. Consequently, the keycap 231 of each key 23 is descended. While the top cover 32 is moved from the closed position to the opened position, the linkage element 311 is no longer pushed by the top cover 32. In response to the elastic force provided by the elastic mechanism 312, the key frame module 24 is moved horizontally in the second direction D2. Under this circumstance, the keycap 231 of each key 23 is ascended, and thus the keyboard 2′ is in a usage status. It is noted that numerous modifications and alterations may be made while retaining the teachings of the invention. For example, the way of moving the linkage element 311 is not restricted to the pushing action of the top cover 32. In another embodiment, the user may manually depress the linkage element 311 to descend the linkage element 311.

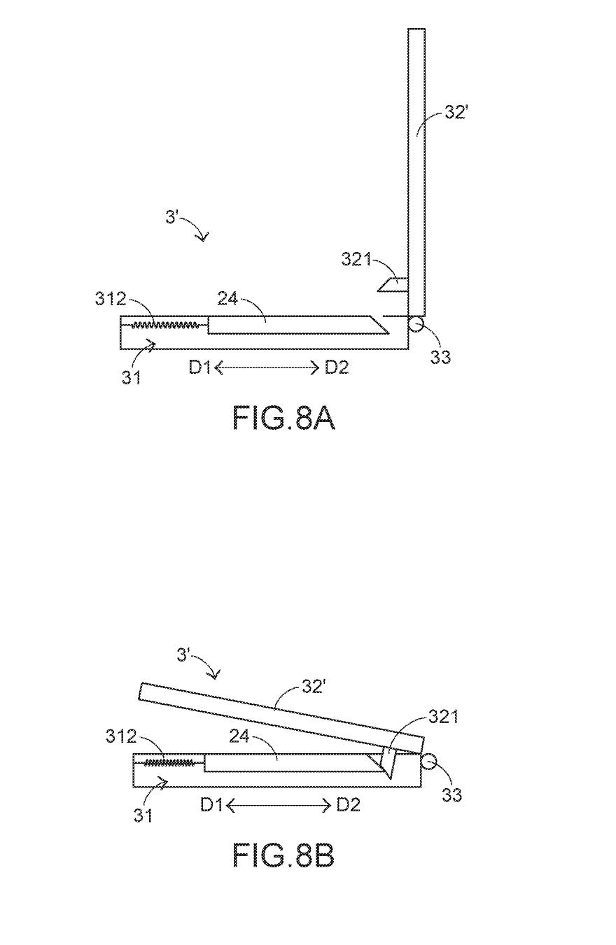

Please refer to FIGS. 8A and 8B. FIG. 8A is a schematic side view illustrating a portion of a notebook computer according to a second embodiment of the present invention, in which the top cover is in the opened position. FIG. 8B is a schematic side view illustrating the notebook computer of FIG. 8A, in which the top cover is moved from the opened position to the closed position. The components of the notebook computer 3′ that are similar to those of the above embodiment are not redundantly described herein. In comparison with the above embodiments, a linkage element 321 is protruded from the top cover 32′. While the top cover 32′ is moved from the opened position to the closed position, the linkage element 321 is inserted into the keyboard base 31 to push the key frame module 24. Consequently, the key frame module 24 is moved horizontally in the first direction D1, and the keycap 231 of each key 23 is descended. While the top cover 32′ is moved from the closed position to the opened position, the linkage element 321 is gradually detached from the keyboard base 31 and the key frame module 24 is no longer pushed by the linkage element 321. In response to the elastic force provided by the elastic mechanism 312, the key frame module 24 is moved horizontally in the second direction D2. Under this circumstance, the keycap 231 of each key 23 is ascended, and thus the keyboard 2′ is in a usage status.

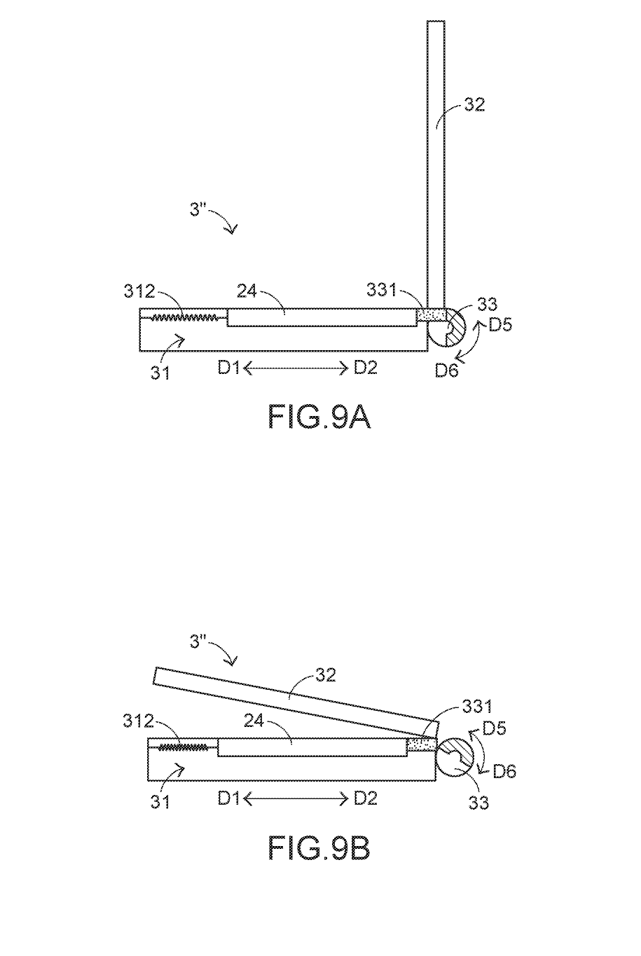

Please refer to FIGS. 9A and 9B. FIG. 9A is a schematic side view illustrating a portion of a notebook computer according to a third embodiment of the present invention, in which the top cover is in the opened position. FIG. 9B is a schematic side view illustrating the notebook computer of FIG. 9A, in which the top cover is moved from the opened position to the closed position. The components of the notebook computer 3″ that are similar to those of the above embodiment are not redundantly described herein. In comparison with the above embodiments, the notebook computer 3″ further comprises a linkage element 331. The linkage element 331 is connected with the key frame module 24. Moreover, as the rotary shaft 33 is rotated, the linkage element 331 is correspondingly moved. While the top cover 32′ is moved from the opened position to the closed position, the rotary shaft 33 is rotated in the counterclockwise direction D5 to push the linkage element 331. Consequently, the key frame module 24 connected with the linkage element 331 is moved horizontally in the first direction D1, and the keycap 231 of each key 23 is descended. While the top cover 32′ is moved from the closed position to the opened position, the rotary shaft 33 is rotated in the clockwise direction D6. Meanwhile, the linkage element 331 is no longer pushed by the rotary shaft 33. In response to the elastic force provided by the elastic mechanism 312, the key frame module 24 is moved horizontally in the second direction D2. Under this circumstance, the keycap 231 of each key 23 is ascended, and thus the keyboard 2′ is in a usage status.

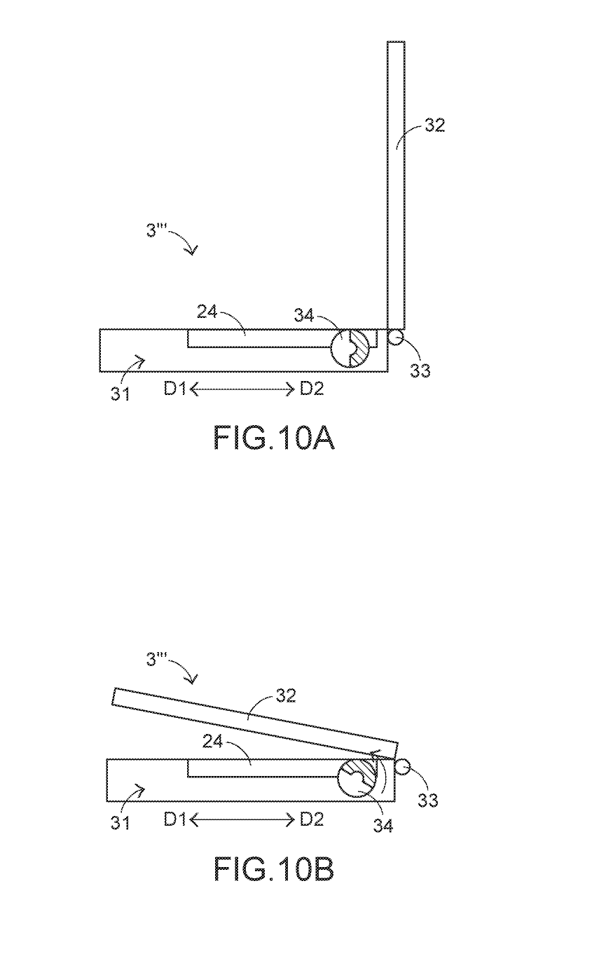

Please refer to FIGS. 10A and 10B. FIG. 10A is a schematic side view illustrating a portion of a notebook computer according to a fourth embodiment of the present invention, in which the top cover is in the opened position. FIG. 10B is a schematic side view illustrating the notebook computer of FIG. 10A, in which the top cover is moved from the opened position to the closed position. The components of the notebook computer 3′″ that are similar to those of the above embodiment are not redundantly described herein. In comparison with the above embodiments, the notebook computer 3′″ further comprises a driving mechanism 34 such as a driving motor. The driving mechanism 34 is disposed within the keyboard base 31 for driving the horizontal movement of the driving mechanism 34. While the top cover 32′ is moved from the opened position to the closed position, the driving mechanism 34 drives the horizontal movement of the key frame module 24 in the first direction D1. Consequently, the keycap 231 of each key 23 is descended. While the top cover 32 is moved from the closed position to the opened position, the driving mechanism 34 drives the horizontal movement of the key frame module 24 in the second direction D2. Under this circumstance, the keycap 231 of each key 23 is ascended, and thus the keyboard 2′ is in a usage status.

From the above descriptions, the present invention provides the keyboard and the notebook computer with the keyboard. While the top cover is moved from the opened position to the closed position, the keys are correspondingly descended. Since the overall thickness of the notebook computer is reduced, the notebook computer can be easily carried. It is noted that numerous modifications and alterations may be made while retaining the teachings of the invention. For example, the number of the linkage elements, the number of the elastic elements, the way of moving the key frame module in the first direction while the top cover is moved from the opened position to the closed position and/or the way of moving the key frame module in the second direction while the top cover is moved from the closed position to the opened position are not restricted.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard, comprising:
a membrane circuit board comprising at least one membrane switch;
at least one key corresponding to the at least one membrane switch, wherein each key comprises a keycap, a bulge and a key frame, wherein when the keycap is depressed, the corresponding membrane switch is turned on, wherein the bulge is connected with a lateral edge of the keycap and protruded externally from the keycap, wherein the key frame comprises a receiving hole and a guiding surface corresponding to the bulge, and the keycap is movable within the receiving hole, wherein while the key frame is moved horizontally, the bulge is pushed by the guiding surface and moved along the guiding surface, so that the keycap is descended; and
a base plate connected with the at least one key.

2. The keyboard according to claim 1, wherein the key frame further comprises a guiding groove, wherein the guiding groove is concavely formed in an inner wall of the key frame, and the guiding groove has the guiding surface.

3. The keyboard according to claim 2, wherein while the keycap is depressed, the bulge is detached from the guiding groove and moved toward the membrane circuit board, wherein when the keycap is no longer depressed, the bulge is moved toward the guiding groove.

4. The keyboard according to claim 2, wherein while the key frame is moved horizontally in a first direction, the keycap is descended, wherein while the key frame is moved horizontally in a second direction, the keycap is ascended, wherein the first direction and the second direction are opposed to each other.

5. The keyboard according to claim 4, wherein the keyboard is installed on a keyboard base, and the keyboard base is pivotally coupled to a top cover, wherein while the top cover is moved from an opened position to a closed position, the key frame is moved horizontally in the first direction, wherein while the top cover is moved from the closed position to the opened position, the key frame is moved horizontally in the second direction.

6. The keyboard according to claim 5, wherein the keyboard further comprises a linkage element, and the linkage element is contacted with the key frame, wherein while the top cover is moved from the opened position to the closed position, the key frame is pushed by the linkage element, so that the key frame is moved horizontally in the first direction.

7. The keyboard according to claim 5, further comprising a driving mechanism, wherein while the top cover is moved from the opened position to the closed position, the key frame is driven to be moved horizontally in the first direction by the driving mechanism.

8. The keyboard according to claim 1, wherein the bulge has a bulge surface in contact with the guiding surface of the key frame, wherein while the key frame is moved horizontally, a position of the bulge surface relative to the guiding surface is changed.

9. The keyboard according to claim 1, wherein each key further comprises a connecting element, wherein the connecting element is connected between the base plate and the keycap, and the keycap is moved upwardly or downwardly relative to the base plate through the connecting element.

10. The keyboard according to claim 9, wherein the connecting element is a scissors-type connecting element.

11. The keyboard according to claim 10, wherein the scissors-type connecting element comprises:
a first frame, wherein a first end of the first frame is connected with the keycap, and a second end of the first frame is connected with the base plate; and
a second frame, wherein a first end of the second frame is connected with the base plate, and a second end of the second frame is connected with the keycap, wherein the second frame is combined with the first frame, and the second frame is rotatable relative to the first frame.

12. The keyboard according to claim 1, wherein each key further comprises an elastic element, and the elastic element is arranged between the keycap and the membrane circuit board, wherein while the keycap is depressed, the elastic element is compressed to trigger the corresponding membrane switch, wherein when the keycap is no longer depressed, the keycap is returned to an original position in response to an elastic force provided by the elastic element.

13. A notebook computer, comprising:
a keyboard base;
a top cover pivotally coupled with the keyboard base; and
a keyboard installed on the keyboard base, wherein the keyboard comprises:
a membrane circuit board comprising at least one membrane switch;
at least one key corresponding to the at least one membrane switch, wherein each key comprises a keycap, a bulge and a key frame, wherein when the keycap is depressed, the corresponding membrane switch is turned on, wherein the bulge is connected with a lateral edge of the keycap and protruded externally from the keycap, wherein the key frame comprises a receiving hole and a guiding surface corresponding to the bulge, and the keycap is movable within the receiving hole; and
a base plate connected with the at least one key,
wherein while the top cover is moved from an opened position to a closed position, the key frame is moved horizontally in a first direction, wherein as the key frame is moved horizontally in the first direction, the bulge is pushed by the guiding surface and moved along the guiding surface, so that the keycap is descended.

14. The notebook computer according to claim 13, wherein the notebook computer further comprises a linkage element, and the linkage element is contacted with the key frame, wherein while the top cover is moved from the opened position to the closed position, the key frame is pushed by the linkage element, so that the key frame is moved horizontally in the first direction.

15. The notebook computer according to claim 13, further comprising a driving mechanism, wherein while the top cover is moved from the opened position to the closed position, the key frame is driven to be moved horizontally in the first direction by the driving mechanism.

16. The notebook computer according to claim 13, wherein each key further comprises an elastic element, and the elastic element is arranged between the keycap and the membrane circuit board, wherein while the keycap is depressed, the elastic element is compressed to trigger the corresponding membrane switch, wherein when the keycap is no longer depressed, the keycap is returned to an original position in response to an elastic force provided by the elastic element.

17. The notebook computer according to claim 16, wherein while the top cover is moved from the closed position to the opened position, the key frame is moved horizontally in a second direction, wherein as the key frame is moved horizontally in the second direction, the keycap is ascended in response to the elastic force of the elastic element, wherein the first direction and the second direction are opposed to each other.

18. The notebook computer according to claim 13, wherein the bulge has a bulge surface in contact with the guiding surface of the key frame, wherein while the key frame is moved horizontally, a position of the bulge surface relative to the guiding surface is changed.

19. The notebook computer according to claim 13, wherein the key frame further comprises a guiding groove, wherein the guiding groove is concavely formed in an inner wall of the key frame, and the guiding groove has the guiding surface.

20. The notebook computer according to claim 19, wherein while the keycap is depressed, the bulge is detached from the guiding groove and moved toward the membrane circuit board, wherein when the keycap is no longer depressed, the bulge is moved toward the guiding groove.
